(19) United States
(12) Patent Application Publication
(10) Pub. No.: US 2016/0299781 A1
(43) Pub. Date: Oct. 13, 2016

(54) OPTIMIZING A PRIORITY QUEUE IN A COMPUTER NETWORK

(71) Applicant: Apollo Education Group, Inc., Phoenix, AZ (US)

(72) Inventors: AMY STANAR, Chandler, AZ (US); YVONNE TURNER, Chandler, AZ (US); ABIGAIL NORBIN, Chandler, AZ (US); AMY WOLFE, San Tan Valley, AZ (US)

(21) Appl. No.: 15/188,923

(22) Filed: Jun. 21, 2016

Related U.S. Application Data
(63) Continuation of application No. 14/045,768, filed on Oct. 3, 2013.

(51) Int. Cl. G06F 9/48; G06Q 30/02; H04L 29/06; G06F 9/50; G06F 17/30

(52) U.S. Cl. CPC G06F 9/4881; G06F 9/5083; G06F 9/5038; G06F 17/3053; H04L 67/42; G06Q 30/0201

(57) ABSTRACT

Optimizing a priority queue for a computer network. In an embodiment, instructions are executed by a server computer, which cause the server computer to maintain the priority queue with a plurality of queue entries, wherein the priority queue includes a first queue entry and a second queue entry, and a first score is associated with the first queue entry, and a second score is associated with the second queue entry; receive, from a first client computer, input indicating performance of a first activity associated with the first queue entry; receive, from a second client computer, input indicating performance of a second activity associated with the second queue entry; update, at the server computer, the first score by the first amount and the second score by a second amount; change, at the server computer, the position of the first queue entry and the second queue entry in the priority queue.

### BENEFIT CLAIMS

This application is a Continuation of U.S. patent application Ser. No. 14/045,768, filed Oct. 3, 2013, the entire contents of which is hereby incorporated by reference for all purposes as if fully set forth herein. The applicant(s) hereby rescind any disclaimer of claim scope in the parent application(s) or the prosecution history thereof and advise the USPTO that the claims in this application may be broader than any claim in the parent application(s).

### FIELD OF THE INVENTION

The present invention generally relates to priority queues and, more specifically, to optimizing a priority queue maintained by a server computer in a computer network. SUGGESTED GROUP ART UNIT: 2447; SUGGESTED CLASSIFICATION 709.

### BACKGROUND

Typically, tasks are assigned to a computer or a user. For example, if a queue has fifty entries, one computer may be assigned a first set of twenty-five queue entries to perform and another computer may be assigned a second set of twenty-five queue entries. However, the first set of twenty-five queue entries may require more work than the second set of twenty-five queue entries. More sophisticated assignments may still lead to uneven workloads.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### TERMS

For purposes of explanation the following terms are defined as follows:

An “organization” is a business, company, firm, group, person, or other entity.

An “offer” is an offer to buy a good or service, a job offer, a promotional offer, an offer to enroll at a school or one or more courses, or any other offer for a sale or transaction.

A “lead” is any entity that an organization desires to perform an action, including but not limited to potential customers, potential clients, potential employees, or other people or entities of interest to an organization. For example, a recent graduate of a primary school or college may be a potential customer, or lead, for a university. A lead may also be an existing customer or client of an organization, to which the organization would like to offer further goods or services. For example, a university may consider a currently enrolled student at the university to be a lead, because the university may wish invite the student to enroll or register for classes offered next semester. Also for example, a bank may consider an account holder at the bank to be a lead, because the bank may wish to offer a new line of credit or some other financial product or service to the account holder. Further, for example, a current employee may be a lead for a promotion within the same organization the employee currently works for.

A “lead profile” is a record, file, or other data that corresponds to, identifies, or describes, a lead. A lead profile may include data about the corresponding lead, such as attributes or behaviors. For example, a lead profile may include the education level, income level, and/or location of a corresponding lead. The lead profile may also include a diary of activities performed by the lead. For example, a lead profile may include data that indicates a corresponding lead has submitted an application to go to a particular university, or to get a particular job. A lead profile may include data that indicates a corresponding lead has clicked on a particular link within an email, or on a website. A lead profile may be stored in volatile and/or non-volatile memory.

A “representative” is a person, company, group, or other entity that contacts or interacts with leads on behalf of an organization. For example, a representative may be a salesperson that contacts or interacts with others to sell goods and services for an organization. A representative for a college may be an enrollment advisor. The enrollment advisor may contact and encourage leads, which have recently graduated from a primary school, to enroll in the college the enrollment advisor represents. In another example, a representative may be a hiring manager that is looking for an employee with a particular skill set. A representative need not be an employee of the organization. For example a representative may be an agent.

### BRIEF DESCRIPTION OF THE DRAWINGS

In the drawings:

FIG. 1 illustrates a block diagram of a system for maintaining a lead queue system, in an example embodiment.

FIG. 2 illustrates a process of a lead queue system creating, updating, and ordering lead profiles, in an example embodiment.

FIG. 3 illustrates a block diagram of a lead profile, in an example embodiment.

FIG. 4 illustrates a prioritization table for prioritizing current and potential students for a university in a lead queue system, in an example embodiment.

FIG. 5 illustrates a block diagram of lead queue system, in an example embodiment.

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method to prioritize leads for a pool of representatives is presented herein. In an embodiment, rather than simply assigning leads to representatives, the leads are maintained in an ordered pool of leads. Within the pool, the leads are ordered based on the likelihood that the leads will perform an act desired by the organization. Consequently, when a representative is ready to contact a lead, the representative may merely select the lead, within the pool, that is estimated to be the most likely to perform the desired act. The likelihood that a lead will perform the desired act may be estimated, for example, based on actions performed by the lead, and/or attributes of the lead, that are detected by the lead prioritization system.

In an embodiment, leads have corresponding lead profiles. Each lead profile includes data that indicates the how likely it is that the corresponding lead will perform the act desired by the organization that maintains the lead profiles.

Each lead profile may have a corresponding queue entry, stored in a priority queue, that references the lead profile. Conversely, each queue entry corresponds to a lead. A priority queue manager manages the priority queue, and orders queue entries in the priority queue based on how likely the corresponding leads are to take an offer. Accordingly, of all the leads with corresponding queue entries, the lead that corresponds to the highest queue entry in the priority queue is estimated to be the lead most likely to perform the act desired by the organization.

A lead profile may be updated automatically based, at least in part, on the actions of the corresponding lead that are detected by the system. For example, through a website, a lead may update data in the lead's lead profile. Based on the update, the system may determine that the lead has more interest than was previously estimated for the lead. In response, the queue manager updates the position of the corresponding queue entry in the priority queue based, at least in part, on the updated lead profile.

A lead profile may be updated manually by a representative, manager, or someone other than the corresponding lead. For example, when a representative of an organization is available to contact a lead, the representative may request the lead profile, or data identifying the lead profile, that corresponds to the highest queue entry. In response, the queue manager may dequeue the highest queue entry. The representative may contact the lead and update the lead profile with any additional data obtained or inferred from the contact. In response, the queue manager may create a new queue entry in the priority queue, which references the updated lead profile. The queue manager also positions the new queue entry within the priority queue based, at least in part, on the updated lead profile.

Representatives may be assigned to one or more pools within an organization, and each pool may have its own priority queue and queue manager. For example, each pool in an organization may be associated with a particular product, and therefore, each representative in a pool may be a specialized representative for the particular product. Representatives in a pool may work collectively to progress leads in the pool's lead queue system through stages of a sale or transaction. Additionally, a representative may belong to more than one pool.

### Lead Queue System

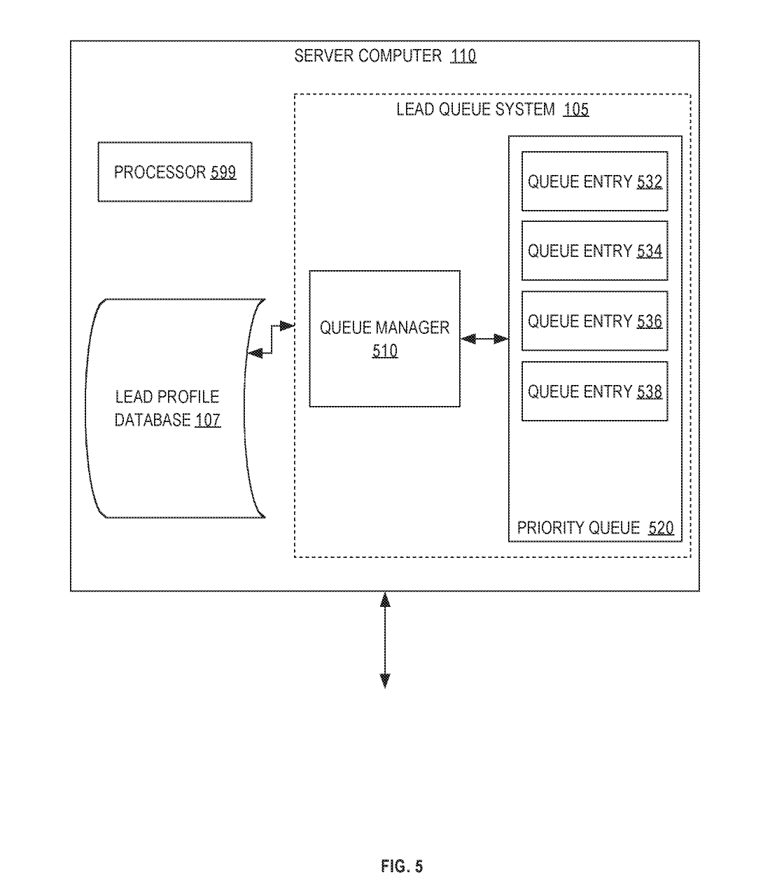

FIG. 5 illustrates a block diagram of lead queue system, in an example embodiment. While FIG. 5 illustrates a particular embodiment for purposes of illustrating a clear example, other embodiments may omit, add to, reorder, and/or modify any of the elements shown. In FIG. 5, server computer 110 is illustrated as if all components are implemented on a single computer; however, server computer 110 may be implemented using multiple computers, such as a database server computer, a file server computer, and one or more server computers prioritizing leads.

In FIG. 5, server computer 110 includes lead queue system 105, lead profile database 107, and processor 599. Lead queue system 105 estimates which leads are most likely to perform a desired act, based on data stored in corresponding lead profiles. In response to a request for data identifying the highest priority lead, lead queue system 105 returns the lead profile, or data associated with the lead profile, that corresponds to the lead estimated to be the most likely lead to perform a desired act.

Lead queue system 105 includes queue manager 510 and priority queue 520, and is communicatively coupled to lead profile database 107. To illustrate a clear example, queue manager 510 and priority queue 520 are illustrated as distinct components; however, lead queue system 105 may include all the structures, features, and functionality of any of its components discussed herein. Furthermore, lead queue system 105 and lead profile database 107 are illustrated as distinct separate components; however, lead queue system 105 may include lead profile database 107, and/or portions of lead profile database 107.

Lead queue system 105 may be communicatively coupled with software and/or devices running on server computer 110, such as lead profile database 107. Additionally or alternatively, lead queue system 105 is communicatively coupled with remote devices, or software running on remote devices, through server computer 110. Additionally or alternatively, lead queue system 105 may be executed and/or stored in memory on one or more other devices. Additionally or alternatively, lead queue system 105 may be, or may be a part of, a database system, file system, customer relationship management system, cloud computing system, or other storage and/or management system stored and executed on one or more devices. Additionally or alternatively, lead queue system 105 may be implemented as a service, or part of a service, that others may use. For example, lead queue system 105 may be a Software as a Service system, or part of a Software as a Service system.

Processor 599 may comprise a CPU that is configured to execute stored programs and to perform the processes and operations of lead queue system 105, or any of its components, described further herein. Additionally, processor 599 may comprise a CPU that is configured to execute stored programs to perform the processes and operations described further herein for lead profile database 107.

### Lead Profile Database

Lead profile database 107 is a database of lead profiles. Lead profiles in lead profile database 107 may be persistently stored in non-volatile memory, such as a disk. Additionally or alternatively, lead profiles in lead profile database 107 may also be stored in volatile memory. Lead profile database 107 is communicatively coupled with software and/or devices running on server computer 110, such as lead queue system 105. Additionally or alternatively, lead profile database 107 is communicatively coupled with remote devices, or software running on remote devices, through server computer 110. Additionally or alternatively, lead profile database 107 may be, or may be a part of, a database system, file system, customer relationship management system, or other storage and/or management system stored and executed on one or more devices.

A lead profile includes data that indicates the how likely the corresponding lead will perform an act desired by an organization. Data may include, among other things, name, location, income level, current employment, previous employment, endorsements, referrals, letters of recommendation, current and/or previous education, social security number, credit rating, currently owned assets, current yearly income, previous income data, interests, age, date of birth, marital status, number of children, debts, current and/or previous creditors, professional or extracurricular awards or accomplishments, resume and/or curriculum vitae, or data found on a resume and/or curriculum vitae, email address, phone number, mailing address, other contact information, a unique identifier, agent's information, guardian's information, and/or any other data discussed herein, such as a lead score, stage, attributes, etc. Additionally or alternatively, lead profile may include additional information not specifically enumerated.

### Priority Queue

In FIG. 5, priority queue 520 includes a plurality of queue entries: queue entry 532, queue entry 534, queue entry 536, and queue entry 538. Each queue entry in priority queue 520 corresponds to, and references, a lead profile in lead profile database 107. For example, a queue entry may include a unique identifier that identifies a lead profile in lead profile database 107. Additionally or alternatively, a queue entry may include data from the corresponding lead profile. Queue entries in priority queue 520 may be stored contiguously in memory. For example, for example priority queue 520 may be an array, and each element in the array is a queue entry. However, queue entries in priority queue 520 need not be stored contiguously in memory. For example, priority queue 520 may be a linked list, and each queue entry in priority queue 520 is a node in the linked list.

### Queue Manager

Queue manager 510 orders queue entries in priority queue 520. For example, based, at least in part, on lead profiles in lead profile database 107, queue manager 510 orders queue entries in priority queue 520, such that each queue entry in priority queue 520 corresponds to a lead that should be given higher priority than the leads that correspond to queue entries lower in priority queue 520. Thus, the queue entry at the top of priority queue 520 (for example, queue entry 532) corresponds with the lead that should be given the highest priority. Furthermore, the queue entry at the bottom of priority queue 520 (for example, queue entry 538) corresponds with the lead that should be given the least priority. Accordingly, queue manager 510 is communicative coupled with lead profile database 107 through lead queue system 105. Example factors for determining the priority of a lead is discussed in detail in later sections.

Queue manager 510 may reorder queue entries in priority queue 520 as data in lead profile database 107 changes. For example, in response to an update to a lead profile, queue manager 510 may reorder queue entries in priority queue 520. Additionally or alternatively, queue manager 510 may reorder queue entries in priority queue 520 in response to a state change of server computer 110 or lead queue system 105. For example, if the current time stored in lead queue system 105 changes, queue manager 510 may reorder queue entries in priority queue 520. Additionally or alternatively, queue manager 510 may reorder queue entries in priority queue 520 in response to enqueuing or dequeuing queue entries. For example, after a queue entry is dequeued, queue manager 510 may reorder the remaining queue entries in priority queue 520.

Queue manager 510 may implement lazy ordering. Accordingly, instead of reordering queue entries in priority queue 520 when corresponding lead profiles are updated, or lead queue system 105 changes state, queue manager 510 may wait for lead queue system 105 to receive a request. For example, in response to lead queue system 105 receiving a request for the highest priority lead profile, queue manager 510 may reorder queue entries in priority queue 520. After the queue entries in priority queue 520 are reordered based on the lead profiles in lead profile database 107 that correspond with queue entries in priority queue 520. Accordingly, lead queue system 105 may return the lead profile, or data associated with the lead profile, that corresponds with the queue entry that is reordered to the top of priority queue 520.

### Lead Queue System Features and Functionality

Lead queue system 105 may dequeue queue entries. For example, if a representative requests the highest priority lead from lead queue system 105, lead queue system 105 may dequeue the highest queue entry (for example, queue entry 532) and return the lead profile identifier stored in the dequeued queue entry. Additionally or alternatively, a queue entry may have a flag set that indicates it has been dequeued. Additionally or alternatively, lead queue system 105 may return the lead profile, or data from the lead profile, corresponding to the dequeued queue entry.

Lead queue system 105 may enqueue queue entries. For example, if a representative or manager creates a new lead profile in lead profile database 107, then lead queue system 105 may create and insert a new queue entry. Queue manager 510 may update the position of the queue entries, including the new queue entry, in priority queue 520 based, at least in part, on the data stored in the new lead profile. Additionally or alternatively, lead queue system 105 may create a new queue entry for a lead profile when it receives a request to do so from a representative or manager. For example, after a representative requests the highest priority lead from lead queue system 105, lead queue system 105 may dequeue the highest queue entry in priority queue 520 and return the corresponding lead profile. The representative may contact the corresponding lead. The representative may update the corresponding lead profile, and request that lead queue system 105 enqueue the lead, or lead profile. In response, lead queue system 105 may create and insert a new queue entry that references the lead profile into priority queue 520. Queue manager 510 may update the position of the queue entries in priority queue 520 based, at least in part, on the data stored in the updated lead profile. Additionally or alternatively, if a queue entry has a flag set that indicates it has been dequeued, lead queue system 105 may enqueue the queue entry by clearing the flag.

For convenience of expression, enqueuing a lead or lead profile means enqueuing a queue entry in priority queue 520 that corresponds to the lead or lead profile. Dequeuing a lead or lead profile means dequeuing the queue entry from priority queue 520 that corresponds to the lead or lead profile. Prioritizing, ordering, or reordering a lead or lead profile means ordering or reordering the queue entry in priority queue 520 that corresponds with the lead or lead profile. The priority or order of leads or lead profiles refers to the order of the corresponding queue entries in priority queue 520. A first lead that has priority over a second lead means that a first queue entry, which corresponds to the first lead, is higher in priority queue 520 than a second queue entry, which corresponds to the second lead. Returning a lead means returning the lead profile, or data included in or associate with the lead profile, that corresponds with the lead.

### Network Topology

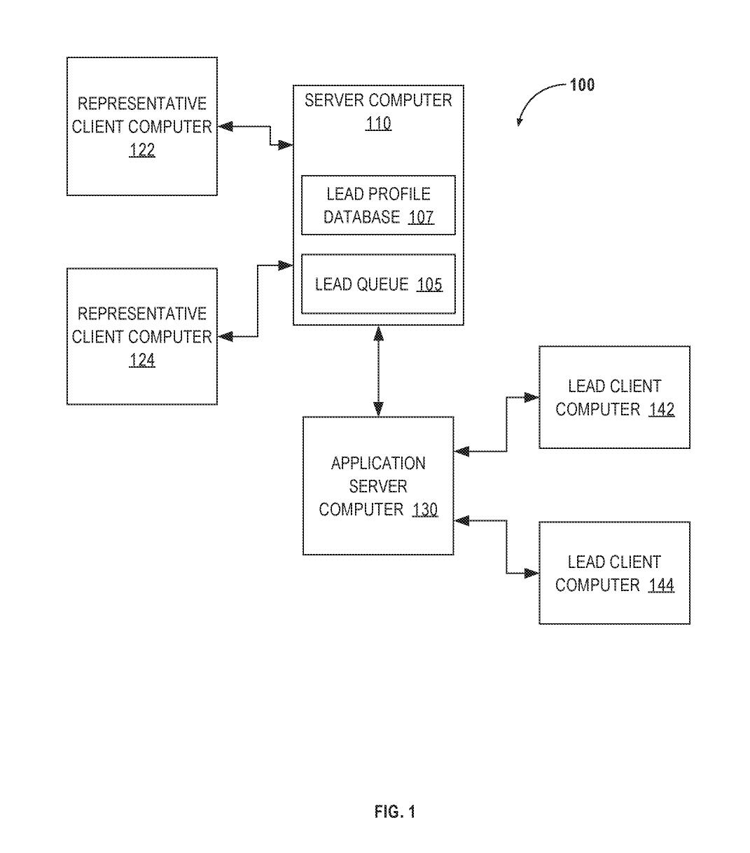

FIG. 1 illustrates a block diagram of a system for maintaining a lead queue system, in an example embodiment. While FIG. 1 illustrates a particular embodiment for purposes of illustrating a clear example, other embodiments may omit, add to, reorder, and/or modify any of the elements shown. In FIG. 1, system 100 includes server computer 110, lead queue system 105, and lead profile database 107, discussed above. Server computer 110 is communicatively coupled with representative client computer 122, representative client computer 124, and application server computer 130. Server computer 110 is communicatively coupled to lead client computer 142 and lead client computer 144 through application server computer 130. Additionally or alternatively, server computer 110 is directly coupled with lead client computer 142 and lead client computer 144. Additionally or alternatively, server computer 110 may be communicatively coupled with lead client computer 142 and lead client computer 144 through one or more other components or devices. Additionally or alternatively, server computer 110 and application server computer 130 may be the same computer(s) or device(s).

### Representative Client Computer

Representative client computer 122 and representative client computer 124 are each operated, at least in part, by one or more representatives of an organization. A representative may, or may cause to, create, retrieve, update, request, delete, enqueue, and/or dequeue leads or lead profiles as discussed herein using either representative client computer 122 and/or representative client computer 124. Accordingly, representative client computer 122 and representative client computer 124 are communicatively coupled with lead profile database 107 and lead queue system 105 through server computer 110. Additionally or alternatively, representative client computer 122 and representative client computer 124 are communicatively coupled with lead profile database 107 and lead queue system 105 though one or more other devices and/or components. Additionally or alternatively, server computer 110 may also be a representative computer. Additionally or alternatively, the representative computer may maintain its own lead profile database and/or lead queue system for the one or more representatives using the representative computer.

### Application Server Computer

Application server computer 130 provides an interface for lead client computers, such as lead client computer 142 and lead client computer 144, which may, or may cause to, to create, retrieve, update, reorder, and/or delete lead profiles. Accordingly, application server computer is communicatively coupled to lead profile database 107. For example, application server computer 130 may be a web server computer programmed to respond to HTTP requests from a browser running on a client computer.

In FIG. 1, application server computer 130 is communicatively coupled with lead profile database 107 through server computer 110. Additionally or alternatively, application server computer 130 and server computer 110 are the same computer and/or device. Additionally or alternatively, application server computer 130 is communicatively coupled with lead profile database 107 through one or more other devices and/or components.

Application server computer 130 may be a server computer that communicates with one or more desktop and/or mobile applications running on one or more lead client computers. Application server computer 130 may be more than one computer. Application server computer 130 may execute multiple independent programs or applications, each of which may, or may cause to, create, retrieve, update, reorder, and/or delete lead profiles.

Application server computer 130 may update lead profiles to indicate which leads perform particular activities. For purposes of illustrating a clear example, assume application server computer 130 is a university enrollment and registration web server computer programmed to respond to HTTP requests. Also assume that application server computer 130 receives, from a lead using lead client computer 142, one or more HTTP requests for a web page with enrollment data. In response, application server computer 130 may determine that a link was selected and/or a page was viewed. Furthermore, application server computer 130 may update the lead profile that corresponds to the lead using lead client computer 142 with data indicating that the lead requested enrollment data. The one or more HTTP requests may be generated in response to the lead selecting a link in an email or browser.

For purposes of illustrating another example of application server computer 130 updating lead profiles to indicate which leads perform particular activities, assume application server computer 130 is a university enrollment and registration web server computer programmed to respond to HTTP requests. Also assume application server computer 130 receives one or more HTTP requests with enrollment application data from a particular lead. Accordingly, application server computer 130 may update the corresponding lead profile to indicate that the lead submitted an application.

### Lead Client Computers

Lead client computer 142 and lead client computer 144 are computers that leads may use to, or cause to, create, retrieve, update, reorder, and/or delete lead profiles. Accordingly, lead client computer 142 and lead client computer 144 are communicatively coupled with lead profile database 107. For example, a user, or lead, using lead client computer 142 may login to a university's website hosted on application server computer 130. The lead may submit an application for enrollment, register for classes, request to have an advisor call her, update her profile, apply for a job at the university, and/or purchase university goods or services through application server computer 130. Accordingly, application server computer 130 may update the corresponding lead profile based activities or actions the lead performs.

In FIG. 1, lead client computer 142 and lead client computer 144 are communicatively coupled with lead profile database 107 through application server computer 130 and server computer 110. Additionally or alternatively, lead client computer 142 and lead client computer 144 are communicatively coupled with lead profile database 107 through one or more other devices and/or components.

For purposes of illustrating a clear example of a lead client computer creating a lead profile through application server computer 130, assume application server computer 130 is a university enrollment and registration web server computer programmed to respond to HTTP requests. In response to receiving one or more HTTP requests from a lead using lead client computer 142 to create a profile, application server computer 130 may create a lead profile stored in lead profile database 107.

For purposes of illustrating a clear example of a lead client computer updating and reordering a lead profile in lead profile database 107 through application server computer 130, assume application server computer 130 is a university enrollment and registration web server computer programmed to respond to HTTP requests. Also assume that application server computer 130 receives data, through one or more HTTP requests from a lead using lead client computer 142, indicating the lead has sufficient financial means to pay tuition. Accordingly, application server computer 130 updates the corresponding lead profile in lead profile database 107. Upon updating the lead profile, lead queue system 105 may reorder the position of the updated lead profile within lead queue system 105. Additionally or alternatively, in response to a request from application server computer 130 or a lead through lead client computer 142, lead queue system 105 may reorder the position of the updated lead profile within lead queue system 105.

### Process Overview

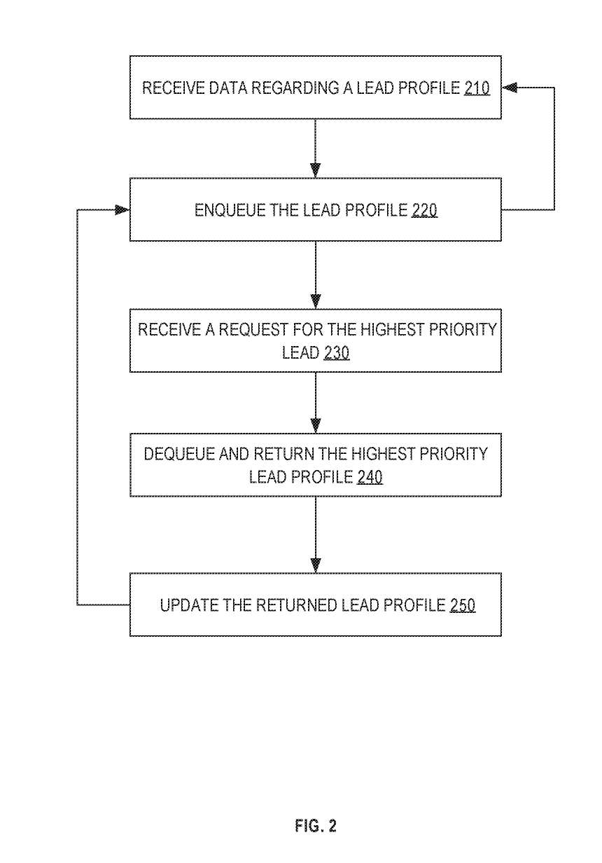

FIG. 2 illustrates a process of a lead queue system creating, updating, and ordering lead profiles, in an example embodiment. While FIG. 2 illustrates example steps according to an embodiment, other embodiments may omit, add to, reorder, and/or modify any of the steps shown. For purposes of illustrating a clear example, FIG. 2 may be described with reference to FIG. 1, but using the particular arrangement illustrated in FIG. 1 is not required in other embodiments.

Now turning to FIG. 2, in step 210, a lead profile database receives data regarding a lead profile. For example, a lead, through lead client computer 142, may browse to an organization's website hosted on application server computer 130 and create a lead profile as discussed above. The lead profile may include personal data derived and/or received from the lead. Application server computer 130 sends the lead profile to lead profile database 107, though server computer 110. Lead profile database 107 stores the lead profile. Additionally or alternatively, lead profiles stored in lead profile database 107 may be generated by, or include data from, other sources, such as lead lists purchased from other organizations.

The lead may also perform activities and/or submit additional data through application server computer 130. For example, a lead may submit an application for a job, make one or more transactions, or register for one or more classes through application server computer 130. Application server computer 130 may store activity data in lead profile database 107 indicating which activities the lead performed.

In step 220, a lead queue system enqueues the lead profile. For example, lead queue system 105 enqueues the lead profile generated in step 210 and stored in lead profile database 107. Lead queue system 105 may order and/or reorder one or more lead profiles in lead profile database 107. Example factors used to determine the priority of leads or lead profiles are discussed in detail in the sections below. In response to the lead submitting additional data, control may return to step 210. Furthermore, in response to other leads submitting additional data to be stored in their respective corresponding lead profiles, control may return to step 210.

In step 230, the lead queue system receives a request for the highest priority lead. For example, when a representative is available to contact a lead, the representative may press a button in a user interface, such as a touch screen, keyboard, or mouse, to request the highest priority lead from lead queue system 105 through representative client computer 122 and server computer 110. Accordingly, lead queue system 105 receives the request for the highest priority lead. Additionally or alternatively, representative client computer 122 may automatically make a request for the highest priority lead. For example, in response to a representative logging in or hanging up a phone, representative client computer 122 may make a request for the highest priority lead from lead queue system 105. The client computer may make the request through HyperText Transfer Protocol (HTTP) or any other standard or proprietary protocol.

In step 240, the lead queue system dequeues and returns the highest priority lead profile. For example, lead queue system 105, in response to the request from representative client computer 122, dequeues the highest lead profile. Lead queue system 105 also returns the dequeued lead profile to representative client computer 122. Accordingly, in response to subsequent requests for the highest priority lead profile, lead queue system 105 will not return the dequeued, returned lead profile, at least until the lead profile has been enqueued again.

In step 250, the representative updates the returned lead profile. For example, the representative that requested the returned lead profile may call the corresponding lead. On the call, the lead may provide additional data about the lead or the lead's activities, such as the lead has submitted an application to attend a university, the lead is interested buying a particular product or service, the lead made a transaction, or the lead no longer wishes to be contacted. The representative may update the lead profile stored in lead profile database 107 with the additional data, through representative client computer 122 and server computer 110. The representative may request to lead queue system 105 to enqueue the updated lead profile, and lead queue system 105 proceeds to revisit step 220. Additionally or alternatively, lead queue system 105 may automatically proceed to revisit step 220, and enqueue the updated lead profile when the lead profile is updated, without receiving a request.

Alternatively, lead queue system 105 may not proceed to step 220. For example, if the lead informs a representative that the lead is no longer interested, then the representative need not send a request to lead queue system 105 to enqueue the lead profile. Additionally or alternatively, lead queue system 105 may not enqueue the lead profile based, at least in part on the updated lead profile. For example, lead queue system 105 may determine based, at least in part, on the additional data in the updated lead profile, that the lead purchased a good or service. If the lead is not likely to purchase the item again, then lead queue system 105 need not enqueue the lead profile.

The steps above may be performed concurrently. For example, a lead may update her lead profile with new data through lead client computer 142 and application server computer 130. Application server computer 130 may send the updated data to lead profile database 107 to update the corresponding lead profile, and lead queue system 105 may reorder the lead profile. Concurrently, a representative may be interacting with a different lead. The representative may send data to lead profile database 107, through representative client computer 122 and server computer 110, to update the corresponding lead profile. The representative may then request that the lead queue system 105 enqueue or reorder the updated lead profile.

### Factors for Ordering Leads within a Lead Queue System

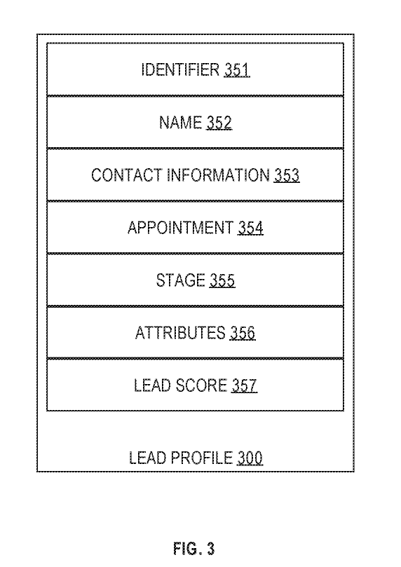

A lead queue system prioritizes leads based on many factors, including data stored in, or associated with, lead profiles. Furthermore, a lead queue system may prioritize leads based on any combination of data stored in the corresponding lead profiles. FIG. 3 illustrates a block diagram of a lead profile, in an example embodiment. While FIG. 3 illustrates a particular embodiment of a lead profile for purposes of illustrating a clear example, other embodiments may omit, add to, reorder, and/or modify any of the elements shown. In FIG. 3, lead profile 300 includes identifier 351, name 352, contact information 353, appointment 354, stage 355, attributes 356, and lead score 357. Identifier 351 is a unique identifier that identifies lead profile 300, such as a number, character string, username, or email address. Name 352 is the name of the corresponding lead, such as the lead's name or organization's name. Contact information 353 may include any data associated with contacting the lead, such as a telephone number, email address, street address, guardian's or representative's name, and/or an indication as to which method of contact the lead prefers.

### Appointment

Appointment 354 may be a date and/or time that the lead is expecting to talk to, or interact with, a representative. For example, the lead corresponding to lead profile 300 may have requested that a representative call the lead within a particular time range on any number of dates, such as between noon and 1:00 PM, Monday through Friday. Accordingly, the particular time range may be stored in appointment 354. Additionally or alternatively, the lead may designate a particular date and time the lead wants to meet with the representative. For example, appointment 354 may be set to Dec. 31, 2013, from 1:00 to 1:30 PM Pacific Standard Time. Accordingly, the meeting time may be stored in appointment 354.

Lead profiles may be ordered in a lead queue system based, at least in part, on an appointment. For purposes of illustrating a clear example, assume a first lead corresponds with queue entry 532, and has an appointment scheduled for today at 2:00 PM; data indicating the appointment time is stored in the corresponding lead profile. Further assume that a second lead corresponds with queue entry 534, and has an appointment scheduled for today at 2:30 PM; data indicating the appointment time is stored in the corresponding lead profile. Accordingly, lead queue system 105 may order queue entry 532 above queue entry 534, because the first lead has an earlier appointment.

If a lead has an appointment, but no representative contacted the lead, then the lead may have a higher priority until the lead is contacted. Alternatively, leads with appointments that have already passed may have a lower priority.

### Stage

Stage 355 may indicate which activities the lead has performed. For example, if stage 355 is set to “qualified,” then the lead that corresponds to lead profile 300 may have performed one or more qualifying activities, such as leaving a phone number, opening an email, selecting a link, logging into a portal, talking to a representative, taking an assessment, and/or visiting a website.

Stage 355 may indicate the engagement level of a lead. For purposes of illustrating a clear example, assume a system has three levels of engagement: “Engaged 1,” “Engaged 2,” and “Engaged 3.” If the lead corresponding to lead profile 300 performs a task, then stage 355 may be set to a higher engagement level, such as “Engaged 3.” If the lead fails to perform a task, or performs an action that shows disinterest, then stage 355 may be set to a lower engagement level, such as “Engaged 1.”

Stage 355 may indicate which stage in a sales pipeline the corresponding lead is in. For the purpose of illustrating a clear example, assume a university has a pipeline with four stages: “New Lead,” “Enrollment Ready,” “Application Submitted,” and “Application Accepted.” Assume that the university receives a new lead, and generates lead profile 300. Accordingly, stage 355 is set to “New Lead.” Further assume, a representative for the university contacts the lead and determines that the lead is a high school graduate and has a desire to attend the university. Accordingly, the representative sets stage 355 to “Enrollment Ready.” Furthermore, assume that the lead electronically submits an application to enroll at the university through the university website. Accordingly, the web server computer(s) that power the university website may update stage 355 to “Application Submitted.” Further still, assume an administrator reviews and approves the lead's application. Accordingly, the administrator may update stage 355 to “Application Accepted.”

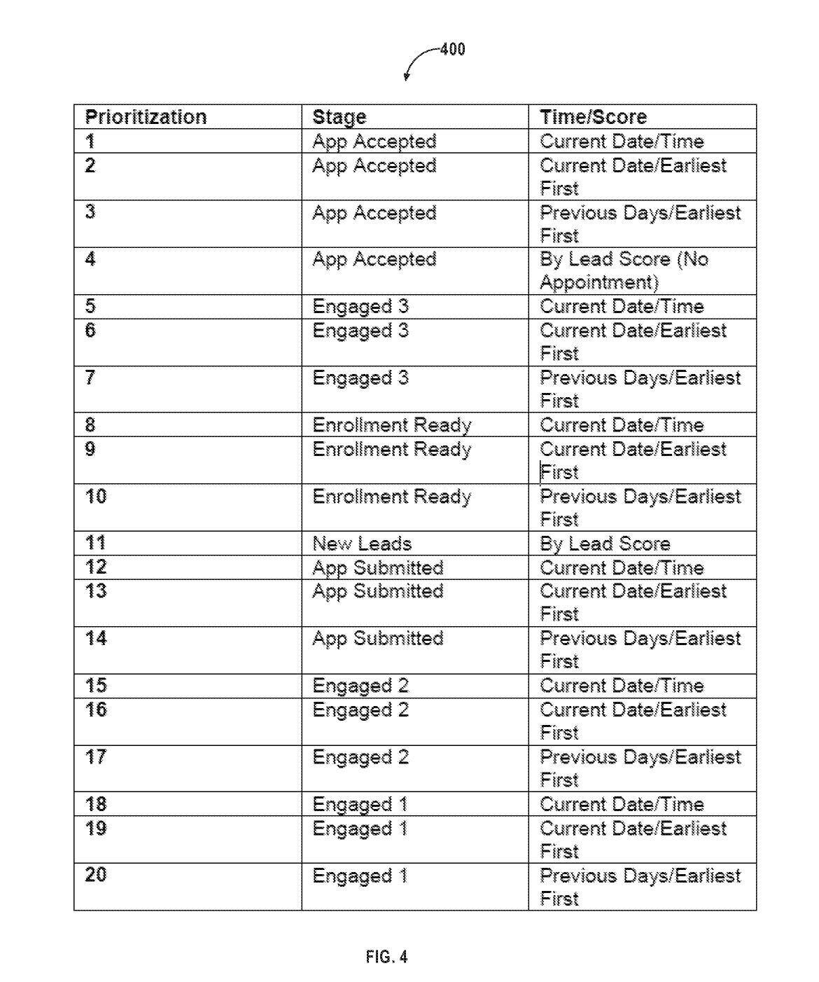

Stage 355 may indicate a combination of activities performed by a lead, the lead's engagement level, and/or the stage in the sales pipeline a lead is in. An example, according to an embodiment, is illustrated in FIG. 4 and discussed in detail below.

Lead profiles may be ordered in a lead queue system based, at least in part, on the state the lead is in. For purposes of illustrating a clear example, assume a first lead corresponds with queue entry 532, and is in a first stage; data indicating that the first lead is in the first stage is stored in the corresponding lead profile. Further assume a second lead corresponds with queue entry 534, and is in a second stage; data indicating that the second lead is in the second stage is stored in the corresponding lead profile. Also assume that the first stage is further in the stage pipeline than the second stage. Accordingly, lead queue system 105 may order queue entry 532 above queue entry 534, because the first lead is in a stage that is further in the stage pipeline.

### Attributes

Attributes 356 may indicate one or more attributes that the lead has. For purposes of illustrating a clear example, assume a lead that corresponds to lead profile 300 is a prospective student at a university. Also assume that the lead qualifies for one or more particular student loans. Accordingly, data stored in attributes 356 indicate that the prospective student is financially independent (or has the ability to pay tuition).

Additionally or alternatively, data may be stored in attributes 356 that indicate other attributes, such as a lead has one or more other higher education degrees or credits, a desire to start as soon as possible, family support, a desire to earn a degree from a university, been expelled from a primary or secondary school, and/or a low primary school grade point average.

Lead profiles may be prioritized based, at least in part, on attributes stored in each lead profile. For purposes of illustrating a clear example, assume a first lead corresponds with queue entry 532, and has a first level of education; data indicating that the first lead has a first level of education is stored in the corresponding lead profile. Further assume that a second lead corresponds with queue entry 534, and has a second level of education; data indicating that the second lead has a second level of education is stored in the corresponding lead profile. Assume that the first level of education is greater than the second level of education. Accordingly, lead queue system 105 may order queue entry 532 above queue entry 534, because the first lead has a higher level of education.

### Lead Score

Lead score 357 may be a value that indicates the propensity or readiness a lead has to accept an offer. For purposes of illustrating a clear example, assume that a first lead lives ten miles from a university, and a second lead lives fifty miles from the university. Also assume that the closer a lead lives to the university, the more likely the lead will attend the university and the higher the lead's lead score ought to be. Accordingly, because the first lead lives closer to the university than the second lead, the calculated lead score for the first lead may be higher than the calculated lead score for the second lead.

Many factors, including attributes stored in attributes 356, may be used to calculate lead score 357. For example, several factors may indicate the propensity for a lead to attend a university: ability to pay, academic achievements, intended start date, support from family or friends, and/or aspirations to attain a particular degree level. Similar factors may indicate a propensity for a lead to buy a product or service: ability to pay, date the product or service is needed, and/or desire to attain the product or service. Similar factors may indicate a propensity for a lead to be successful at a particular job: ability to get to work, academic achievements, intended start date, support from family or friends, and/or aspirations to work in a particular field.

Lead profiles may be ordered in a lead queue system based, at least in part, on a lead score. For purposes of illustrating a clear example, assume a first lead corresponds with queue entry 532, and has a first lead score stored in the corresponding lead profile. Also assume a second lead corresponds with queue entry 534, and has a second lead score stored in the corresponding lead profile. Assume that the first lead score is greater than the second lead score. Accordingly, lead queue system 105 may order queue entry 532 above queue entry 534, because the first lead has a greater lead score than the second lead.

### Other Factors and Factor Interdependencies

A lead may be prioritized based on how recently the lead was contacted by a representative. For example, if a lead was contacted recently, an unscheduled follow up call may not be an efficient use of a representative's time.

In an embodiment, each lead is prioritized based on the lead score stored in the corresponding lead profile. If a first lead has a lead score that is the same as a second lead, then the first lead may be prioritized over the second lead based, at least in part, on other data stored in the corresponding lead profiles as discussed herein.

One factor may be based, at least in part, on one or more other factors. For example, if a new lead, which corresponds with lead profile 300, makes an appointment with a representative, then appointment 354 may be set; additionally, stage 355 may indicate that the lead has advanced to a new stage: “qualified.”

### An Example Embodiment for Ordering Leads that are Students or Potential Students for a University

FIG. 4 illustrates a prioritization table for prioritizing current and potential students for a university in a lead queue system, in an example embodiment. While FIG. 4 illustrates a particular embodiment for purposes of illustrating a clear example, other embodiments may omit, add to, reorder, and/or modify any of the elements shown. For purposes of illustrating a clear example, FIG. 4 may be described with reference to FIG. 1, FIG. 3, and FIG. 5, but using the particular arrangements illustrated in FIG. 1, FIG. 3, and FIG. 5 are not required in other embodiments. In FIG. 4, prioritization table 400 indicates how leads may be prioritized within lead queue system 105. Leads that are classified in a prioritization closer to prioritization 1 are higher in the lead queue system. Leads that are classified in a prioritization closer to prioritization 20 are lower in the lead queue system. Leads that are not classified in any prioritization may be prioritized based, at least in part, on data stored in the corresponding lead profiles. Alternatively, leads that are not classified may have the lowest priority. Alternatively, leads that are not classified may be dequeued.

### Prioritization 1

In the embodiment illustrated in FIG. 4, a lead classified in prioritization 1 has the highest priority in a lead queue system. Since prioritization 1 represents the “highest” priority classification, all other classifications are treated as being “lower” or “below” prioritization 1.

For purposes of illustrating a clear example, assume that a lead, corresponding to queue entry 532, and lead profile 300, is a current student that is eligible to register for classes next semester. Accordingly, stage 355 is set to “App Accepted,” since the lead's status as a “current student” indicates that the lead's application was already accepted. Furthermore, assume that the lead has an appointment with a counselor on Dec. 1, 2013, at 2:00 PM to 2:30 PM, Pacific Standard Time (“PST”), and that appointment 354 is set accordingly. Also assume that the current date and time is Dec. 1, 2013, at 2:10 PM PST. Since the lead's application is already accepted and the current time is within the lead's appointment, then the lead is classified in prioritization 1 and queue entry 532 is ordered at the top of priority queue 520.

If more than one lead is classified in prioritization 1, then the lead queue system may use other data stored in, or associated with, the corresponding lead profiles to determine which leads have a higher priority. For example, the lead or lead profile with the highest lead score may have the highest priority.

### Prioritization 2

A lead classified in prioritization 2 is prioritized in a lead queue system behind any leads classified in prioritization 1. For purposes of illustrating a clear example, assume that a lead, corresponding to queue entry 534, and lead profile 300, is a current student that is eligible to register for classes next semester. Accordingly, stage 355 is set to “App Accepted,” since the lead's status as a “current student” indicates that the lead's application has already been accepted. Furthermore, assume that the lead had an appointment with a counselor on Dec. 1, 2013, at 1:00 PM to 1:30 PM PST, and that appointment 354 is set accordingly. Also assume that the current date and time is Dec. 1, 2013, at 2:10 PM PST. Since the lead's application is already accepted and the current time is past the lead's appointment, but the appointment date is the same as the current date, then the lead is classified in prioritization 2 and is ordered in lead queue system 105 behind any leads classified in prioritization 1. Thus, queue entry 534 is below queue entry 532.

If more than one lead is classified in prioritization 2, then the leads classified in prioritization 2 are prioritized by the earliest missed appointment time. For example, assume that a first lead had a missed appointment scheduled at 10:00 AM to 10:30 AM PST today, and a second lead had a missed appointment scheduled at 11:00 AM to 11:30 AM PST today. Also assume that the current time is 2:10 PM PST. Because the first lead's missed appointment was earlier in the day than the second lead's missed appointment, then the first lead has priority over the second lead. If both leads had an appointment scheduled at the same time, then the lead queue system may use other data stored in, or associated with, the corresponding lead profiles to determine which lead has higher priority.

### Prioritization 3

A lead profile classified in prioritization 3 is prioritized in a lead queue system behind any leads classified in prioritization “above” prioritization 3 (i.e. prioritizations 1 and 2). For purposes of illustrating a clear example, assume that a lead, corresponding to queue entry 536, and lead profile 300, is a current student that is eligible to register for classes next semester. Accordingly, stage 355 is set to “App Accepted,” since the lead's status as a “current student” indicates that the lead's application has already been accepted. Furthermore, assume that the lead had an appointment with a counselor on Nov. 30, 2013, at 1:00 PM to 1:30 PM PST, and that appointment 354 is set accordingly. Also assume that the current date and time is Dec. 1, 2013, at 2:10 PM PST. Since the lead's application is already accepted and the current date is after the appointment date, regardless of the time of day, then the lead is classified in prioritization 3 and is ordered in lead queue system 105 behind any leads classified in prioritization 2 or above. Thus, queue entry 536 is below queue entry 534.

If more than one lead is classified in prioritization 3, then the leads classified in prioritization 3 are prioritized by the earliest missed appointment date, regardless of the appointment time. For example, assume that a first lead had a missed appointment scheduled on Nov. 29, 2013, at 10:00 AM to 10:30 AM PST, and a second lead had a missed appointment scheduled on Nov. 30, 2013, at 9:00 AM to 9:30 AM PST. Also assume that the current date and time is Dec. 1, 2013, at 2:10 PM PST. Because the first lead's missed appointment date was earlier than the second lead's missed appointment, then the first lead has priority over the second lead. If both students had an appointment scheduled on the same date, then the lead queue system may use other data (such as appointment time) stored in, or associated with, the corresponding lead profiles to determine which lead has higher priority.

### Prioritization 4

A lead profile classified in prioritization 4 is prioritized in a lead queue system behind any leads classified in prioritization 3 or above. For purposes of illustrating a clear example, assume that a lead, corresponding to queue entry 538, and lead profile 300, is a current student that is eligible to register for classes next semester. Accordingly, stage 355 is set to “App Accepted,” since the lead's status as a “current student” indicates that the lead's application has already been accepted. Furthermore, assume that the lead does not have an appointment. Since the lead's application is already accepted and no appointment is scheduled, then the lead is classified in prioritization 4 and is ordered in lead queue system 105 behind any leads classified in prioritization 3 or above. Thus, queue entry 538 is below queue entry 536.

If more than one lead is classified in prioritization 4, then the leads classified in prioritization 4 are prioritized by the lead score. For example, assume that a first lead has a lead score of 10, and a second lead has a lead score of 5. Because the first lead's lead score is greater than the second lead's lead score, then the first lead has priority over the second lead. If both leads have the same lead score, then the lead queue system may use other data (such as, number of credits previously earned) stored in, or associated with, the corresponding lead profiles to determine which lead has higher priority.

### Prioritization 5

A lead classified in prioritization 5 is prioritized in a lead queue system behind any leads classified in prioritization 4 or above. Similar determinations discussed above with respect to prioritization 1 may be used to determine whether a lead is classified in prioritization 5. However, unlike a lead that is classified in prioritization 1, a lead that is classified in prioritization 5, has a corresponding lead profile with a stage value set to “Engaged 3.” A stage value in a lead profile may be set to, or associated with, “Engaged 3” if the lead profile includes or is associated with data indicating that the lead has performed one or more particular activities and/or has one or more particular attributes, such as responding to an email. If more than one lead is classified in prioritization 5, then similar determinations discussed above with respect to prioritization 1 may be used to determine which of the leads classified as prioritization 5 have a higher priority.

### Prioritization 6

A lead classified in prioritization 6 is prioritized in a lead queue system behind any leads classified in prioritization 5 or above. Similar determinations discussed above with respect to prioritization 2 may be used to determine whether a lead is classified in prioritization 6. However, unlike a lead that is classified in prioritization 2, a lead that is classified in prioritization 6 has a corresponding lead profile with a stage value set to “Engaged 3.” If more than one lead is classified in prioritization 6, then similar determinations discussed above with respect to prioritization 2 may be used to determine which of the leads classified as prioritization 6 have a higher priority.

### Prioritization 7

A lead classified in prioritization 7 is prioritized in a lead queue system behind any leads classified in prioritization 6 or above. Similar determinations discussed above with respect to prioritization 3 may be used to determine whether a lead is classified in prioritization 7. However, unlike a lead that is classified in prioritization 3, a lead that is classified in prioritization 7 has a corresponding lead profile with a stage value set to “Engaged 3.” If more than one lead is classified in prioritization 7, then similar determinations discussed above with respect to prioritization 3 may be used to determine which of the leads classified as prioritization 7 have a higher priority.

### Prioritization 8

A lead classified in prioritization 8 is prioritized in a lead queue system behind any leads classified in prioritization 7 or above. Similar determinations discussed above with respect to prioritization 1 may be used to determine whether a lead is classified in prioritization 8. However, unlike a lead that is classified in prioritization 1, a lead that is classified in prioritization 8, has a corresponding lead profile with a stage value set to “Enrollment Ready.” A stage value in a lead profile may be set to, or associated with, “Enrollment Ready” if the lead profile includes or is associated with data indicating that the lead has performed one or more particular activities and/or has one or more particular attributes, such as having sufficient financial means to pay for tuition. If more than one lead is classified in prioritization 8, then similar determinations discussed above with respect to prioritization 1 may be used to determine which of the leads classified as prioritization 8 have a higher priority.

### Prioritization 9

A lead classified in prioritization 9 is prioritized in a lead queue system behind any leads classified in prioritization 8 or above. Similar determinations discussed above with respect to prioritization 2 may be used to determine whether a lead is classified in prioritization 9. However, unlike a lead that is classified in prioritization 2, a lead that is classified in prioritization 9 has a corresponding lead profile with a stage value set to “Enrollment Ready.” If more than one lead is classified in prioritization 9, then similar determinations discussed above with respect to prioritization 2 may be used to determine which of the leads classified as prioritization 9 have a higher priority.

### Prioritization 10

A lead classified in prioritization 10 is prioritized in a lead queue system behind any leads classified in prioritization 9 or above. Similar determinations discussed above with respect to prioritization 3 may be used to determine whether a lead is classified in prioritization 10. However, unlike a lead that is classified in prioritization 3, a lead that is classified in prioritization 10 has a corresponding lead profile with a stage value set to “Enrollment Ready.” If more than one lead is classified in prioritization 10, then similar determinations discussed above with respect to prioritization 3 may be used to determine which of the leads classified as prioritization 10 have a higher priority.

### Prioritization 11

A lead classified in prioritization 11 is prioritized in a lead queue system behind any leads classified in prioritization 10 or above. A lead that is classified in prioritization 11 has a corresponding lead profile with a stage value set to “New Lead.” A stage value in a lead profile may be set to, or associated with, “New Lead,” if the lead profile includes or is associated with data indicating that the lead has not performed one or more particular activities and/or does not have one or more particular attributes, which would qualify assigning a different stage to the lead profile. Some data about the new lead may be known, such as an address, age, phone number, education history, or other attributes. However, the lead profile associated with the new lead may not include data that indicates that the lead recently submitted an application for enrollment; otherwise, the stage value should be set to “App Submitted.” Similar to prioritization 4, if more than one lead is classified in prioritization 11, then the leads classified in prioritization 11 are prioritized by the lead score.

### Prioritization 12

A lead classified in prioritization 12 is prioritized in a lead queue system behind any leads classified in prioritization 1 or above. Similar determinations discussed above with respect to prioritization 1 may be used to determine whether a lead is classified in prioritization 12. However, unlike a lead that is classified in prioritization 1, a lead that is classified in prioritization 12, has a corresponding lead profile with a stage value set to “App Submitted.” A stage value in a lead profile may be set to, or associated with, “App Submitted” if the lead profile includes or is associated with data indicating that the lead has performed one or more particular activities and/or has one or more particular attributes, which include submitting an application for enrollment. If more than one lead is classified in prioritization 12, then similar determinations discussed above with respect to prioritization 1 may be used to determine which of the leads classified as prioritization 12 have a higher priority.

### Prioritization 13

A lead classified in prioritization 13 is prioritized in a lead queue system behind any leads classified in prioritization 12 or above. Similar determinations discussed above with respect to prioritization 2 may be used to determine whether a lead is classified in prioritization 13. However, unlike a lead that is classified in prioritization 2, a lead that is classified in prioritization 13 has a corresponding lead profile with a stage value set to “App Submitted.” If more than one lead is classified in prioritization 13, then similar determinations discussed above with respect to prioritization 2 may be used to determine which of the leads classified as prioritization 13 have a higher priority.

### Prioritization 14

A lead classified in prioritization 14 is prioritized in a lead queue system behind any leads classified in prioritization 13 or above. Similar determinations discussed above with respect to prioritization 3 may be used to determine whether a lead is classified in prioritization 14. However, unlike a lead that is classified in prioritization 3, a lead that is classified in prioritization 14 has a corresponding lead profile with a stage value set to “App Submitted.” If more than one lead is classified in prioritization 14, then similar determinations discussed above with respect to prioritization 3 may be used to determine which of the leads classified as prioritization 14 have a higher priority.

### Prioritization 15

A lead classified in prioritization 15 is prioritized in a lead queue system behind any leads classified in prioritization 14 or above. Similar determinations discussed above with respect to prioritization 1 may be used to determine whether a lead is classified in prioritization 15. However, unlike a lead that is classified in prioritization 1, a lead that is classified in prioritization 15, has a corresponding lead profile with a stage value set to “Engaged 2.” A stage value in a lead profile may be set to, or associated with, “Engaged 2,” if the lead profile includes or is associated with data indicating that the lead has performed one or more particular activities and/or has one or more particular attributes, such as missing at least one appointment with a counselor. If more than one lead is classified in prioritization 15, then similar determinations discussed above with respect to prioritization 1 may be used to determine which of the leads classified as prioritization 15 have a higher priority.

### Prioritization 16

A lead classified in prioritization 16 is prioritized in a lead queue system behind any leads classified in prioritization 15 or above. Similar determinations discussed above with respect to prioritization 2 may be used to determine whether a lead is classified in prioritization 16. However, unlike a lead that is classified in prioritization 2, a lead that is classified in prioritization 16 has a corresponding lead profile with a stage value set to “Engaged 2.” If more than one lead is classified in prioritization 16, then similar determinations discussed above with respect to prioritization 2 may be used to determine which of the leads classified as prioritization 16 have a higher priority.

### Prioritization 17

A lead classified in prioritization 17 is prioritized in a lead queue system behind any leads classified in prioritization 16 or above. Similar determinations discussed above with respect to prioritization 3 may be used to determine whether a lead is classified in prioritization 17. However, unlike a lead that is classified in prioritization 3, a lead that is classified in prioritization 17 has a corresponding lead profile with a stage value set to “Engaged 2.” If more than one lead is classified in prioritization 17, then similar determinations discussed above with respect to prioritization 3 may be used to determine which of the leads classified as prioritization 17 have a higher priority.

### Prioritization 18

A lead classified in prioritization 18 is prioritized in a lead queue system behind any leads classified in prioritization 17 or above. Similar determinations discussed above with respect to prioritization 1 may be used to determine whether a lead is classified in prioritization 18. However, unlike a lead that is classified in prioritization 1, a lead that is classified in prioritization 18, has a corresponding lead profile with a stage value set to “Engaged 1.” A stage value in a lead profile may be set to, or associated with, “Engaged 1,” if the lead profile includes or is associated with data indicating that the lead has performed one or more particular activities and/or has one or more particular attributes, such as missing more than one appointment with a counselor. If more than one lead is classified in prioritization 18, then similar determinations discussed above with respect to prioritization 1 may be used to determine which of the leads classified as prioritization 18 have a higher priority.

### Prioritization 19

A lead classified in prioritization 19 is prioritized in a lead queue system behind any leads classified in prioritization 18 or above. Similar determinations discussed above with respect to prioritization 2 may be used to determine whether a lead is classified in prioritization 19. However, unlike a lead that is classified in prioritization 2, a lead that is classified in prioritization 19 has a corresponding lead profile with a stage value set to “Engaged 1.” If more than one lead is classified in prioritization 19, then similar determinations discussed above with respect to prioritization 2 may be used to determine which of the leads classified as prioritization 19 have a higher priority.

### Prioritization 20

A lead classified in prioritization 20 is prioritized in a lead queue system behind any leads classified in prioritization 19 or above. Similar determinations discussed above with respect to prioritization 3 may be used to determine whether a lead is classified in prioritization 20. However, unlike a lead that is classified in prioritization 3, a lead that is classified in prioritization 20 has a corresponding lead profile with a stage value set to “Engaged 1.” If more than one lead is classified in prioritization 20, then similar determinations discussed above with respect to prioritization 3 may be used to determine which of the leads classified as prioritization 20 have a higher priority.

### Representative Pools

Representatives may be assigned to one or more pools within an organization. Each representative pool may have its own lead queue system. Representatives assigned to a pool request lead profiles from the pool's lead queue system. Accordingly, representatives contact the leads corresponding to the returned lead profiles. A representative may be assigned to more than one pool.

Representatives assigned to the same pool may work as a team to help leads in the pool's lead queue system to progress in a sales pipeline and/or accept offers. For purposes of illustrating a clear example, assume a first representative and second representative are assigned to a lead pool with a lead queue system. Assume the first representative requests the lead with the highest priority from the lead queue system. In response, the lead queue system returns the highest priority lead to the first representative and dequeues the highest priority lead. Further assume that subsequent to the first representative's request, the second representative requests the lead with the highest priority from the lead queue system. In response, the lead queue system returns the highest priority lead to the second representative and dequeues the highest priority lead, which is a different lead than the first dequeued lead. The first representative may contact the first lead and update the first lead profile with any additional data obtained or inferred from the contact. Likewise, the second representative may contact the second lead and update the second lead profile with any additional data obtained or inferred from the contact. In response, the lead queue system enqueues each lead after each corresponding lead profile is updated. The lead queue system may also reorder the leads. In response to a subsequent request for the highest priority lead, the lead queue system may return the second lead to the first representative; likewise, in response to a subsequent requires for the highest priority lead, the lead queue system may return the first lead to the second representative. Accordingly, the first representative contacts the second lead and the second representative contacts the first lead.

Thus, in the above example, the first representative and the second representative may work together to convert the first lead and the second lead into customers. If one representative is ill, or otherwise unavailable, then the other representatives assigned to the pool may continue to progress the highest priority leads for the entire pool through a sales pipeline or transaction.

In some cases a lead may benefit from speaking to the same representative instead of other representatives in the pool. Thus, a hybrid lead-representative mapping and lead queue system model may be used. For example, a particular lead may request that a particular representative contact her for a particular appointment. The request may be stored in the corresponding particular lead profile. Accordingly, when a representative requests the highest priority lead from the lead queue system, even if the particular lead profile is at the top of the priority queue, the particular lead need not be dequeued and returned unless the requesting representative is the particular representative. If the particular lead is at the top of the priority queue, and a representative other than the particular representative requests the highest priority lead from the lead queue system, then the representative may receive the next highest priority lead that is not assigned or mapped to the particular representative. Additionally or alternatively, to assign a lead to a representative, a lead may be removed from a lead queue system and assigned to a particular representative. When the particular representative or an administrator determines that other representatives in the pool are suitable, then the particular representative or the administrator may request the lead queue system enqueue the lead profile.

### Multiple Lead Queue Systems and Multiple Pools

An organization may have more than one lead queue system. For example, an organization may sell multiple products. The organization may maintain a lead queue system for each product, such that the leads in each lead queue system may have an interest in the corresponding product.

An organization may also have more than one pool of representatives. For example, the organization may create a pool for each product, and assign a lead queue system to one of the pools. Each representative in each pool may be specialized in selling the pool's corresponding product. Additionally or alternatively, one or more representatives may be assigned to more than one pool.

### Hardware Overview

According to an embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

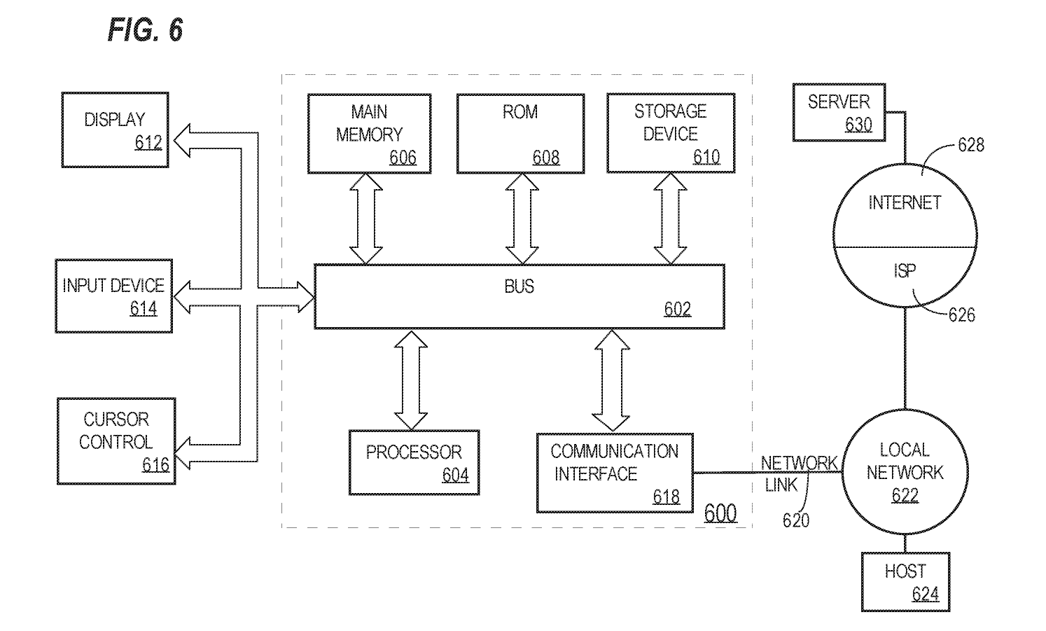

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to an embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server computer 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer system for maintaining a priority queue across a plurality of computers in a computer network comprising:
a memory with a set of instructions;
one or more processors coupled to the memory, wherein the one or more processors execute the set of instructions, which causes the one or more processors to:
maintain, at a server computer, the priority queue with a plurality of queue entries;
maintain, at the server computer, for each queue entry of the plurality of queue entries, a score associated with the queue entry;
wherein the priority queue includes a first queue entry and a second queue entry;
wherein a first score is maintained for the first queue entry, and a second score is maintained for the second queue entry;
receive, at the server computer, from a first client computer, input indicating performance of a first activity associated with the first queue entry;
in response to receiving input indicating performance of the first activity associated with the first queue entry, update, at the server computer, the first score by a first amount;
wherein the first amount is based, at least in part, on the first activity;
in response to updating the first score by the first amount, change, at the server computer, the position of the first queue entry in the priority queue;
receive, at the server computer, from a second client computer, input indicating performance of a second activity associated with the second queue entry;
in response to receiving input indicating performance of the second activity associated with the second queue entry, update, at the server computer, the second score by a second amount;
wherein the second amount is based, at least in part, on the second activity;
wherein the second amount is different than the first amount;
in response to updating the second score by the second amount, change, at the server computer, the position of the second queue entry in the priority queue.
